(19) United States
(12) Patent Application Publication
(10) Pub. No.: US 2013/0124313 A1
(43) Pub. Date: May 16, 2013

(54) METHODS AND SYSTEMS FOR MONETIZING WEB PAGE TRAFFIC

(71) Applicant: GoVista, LLC, Plymouth, MN (US)

(72) Inventors: William Uecker, Plymouth, MN (US); David Kappel, Plymouth, MN (US)

(73) Assignee: GoVista, LLC, Plymouth, MN (US)

(21) Appl. No.: 13/674,511

(22) Filed: Nov. 12, 2012

Related U.S. Application Data
(60) Provisional application No. 61/558,232, filed on Nov. 10, 2011.

(51) Int. Cl. G06Q 30/02

(52) U.S. Cl. 705/14.53

(57) ABSTRACT

The present disclosure relates to novel and advantageous methods and systems for providing a marketing opportunity on a webpage of a browser displayed on a mobile device. The method includes receiving an indication that a user has pressed the “back” button; identifying a cookie for the displayed webpage; and upon receiving an indication that a “back” button has been pressed, redirecting to a webpage selected by a third party.

### CROSS REFERENCE TO RELATED APPLICATION

This application claims priority to U.S. Provisional Application No. 61/558,232, filed on Nov. 10, 2011, which is hereby incorporated herein in its entirety.

### FIELD OF THE INVENTION

A method and system for monetizing web page exit traffic on web enabled mobile devices is provided.

### BACKGROUND OF THE INVENTION

An efficient method or system of monetizing website exit traffic on a web enabled mobile device does not currently exist. Specifically, currently, when a user presses the back button on a mobile device while on a webpage, there is not an efficient method to monetize that exit traffic. As such, there is a need in web-based marketing for a system and method to monetize website or webpage exit traffic on a web enabled mobile device.

### BRIEF SUMMARY OF THE INVENTION

The present disclosure relates to novel and advantageous methods and systems for monetizing web page exit traffic on web enabled mobile devices. In some embodiments of the present disclosure, javascript and web browser cookies can be used to determined when a user is exiting a website or mobile application. Furthermore, when a user exits a website or mobile application, some embodiments may redirect the web browser to a destination URL selected by a third party by identifying the web browser cookie that was initially placed. For example, the cookie may identify whether the visitor has previously visited the page before they travel to the destination URL. If the cookie has not been identified, it is placed and the visitor is redirected to the initial destination URL, for example. But if the cookie is identified then the javascript knows to instead redirect the visitor to the alternative destination URL.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 shows a flow diagram of a method for using the invention of the present disclosure according to one embodiment.

### DETAILED DESCRIPTION

The present disclosure relates to novel and advantageous methods and systems for monetizing web page exit traffic on web enabled mobile devices. In one embodiment, the method or system of the present disclosure comprises the following items or steps: web server; javascript; web browser cookie; HTML; web enabled mobile device; destination URL; web enabled mobile device web browser; web enabled mobile device web browser cache; exit page redirection URL; and/or hyperlink.

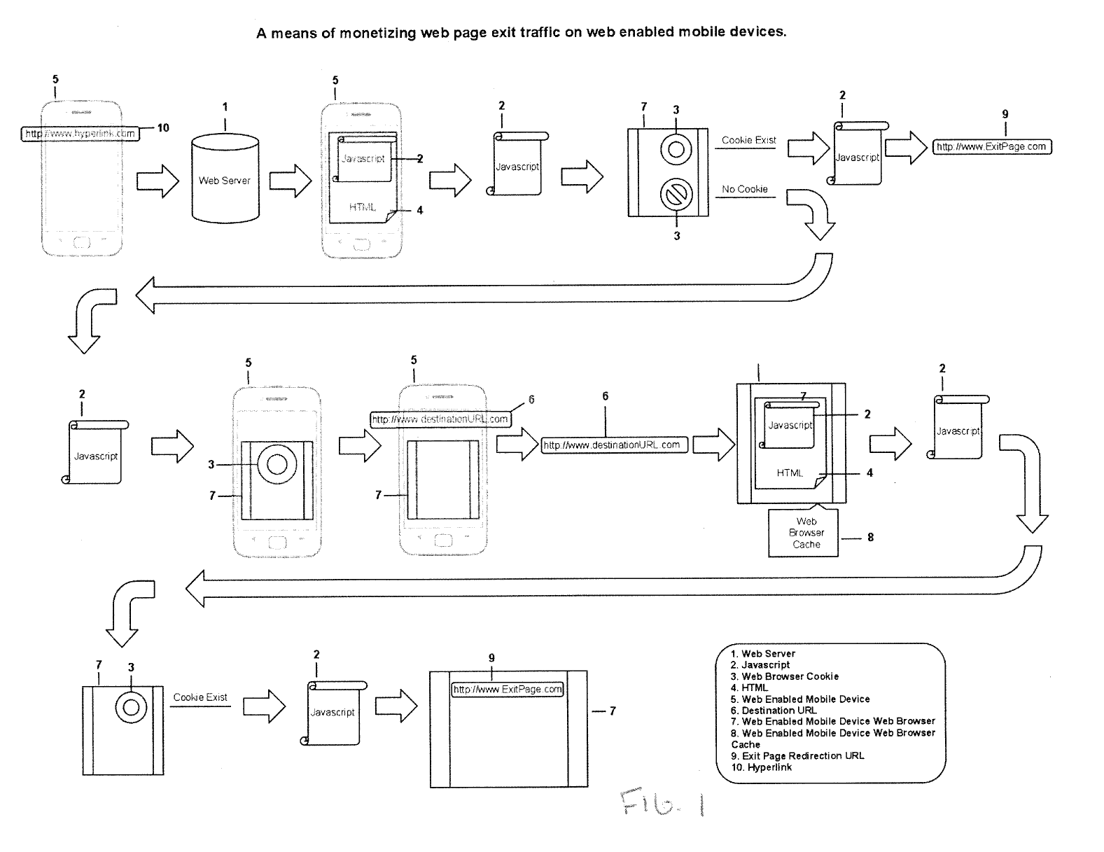

As may be seen in FIG. 1, the items or steps may function in the following way, according to some embodiments. A user of a web enabled mobile device (5) clicks on a hyperlink (10) that sends the web enabled mobile device (5) to a web server (1). The web server (1) receives the request and responds to the web enabled mobile device (5) with a html (4) web page that contains javascript (2). Javascript (2) checks with the web enabled mobile device browser (7) in order to see if the web browser cookie (3) exists. If a web browser cookie (3) does not exist on the web enabled mobile device (5), the javascript (2) will place a web browser cookie (3) on the web enabled mobile device web browser (7). If the web browser cookie (3) exists, then no additional cookie is placed on the mobile device's web browser.

The web enabled mobile device web browser (7) is then redirected to the destination URL (6). Upon exiting the destination URL (6), the web enabled mobile device's web browser (7) loads the initial html (4) web page from it's web enabled mobile device web browser cache (8) at which point the javascript (2) identifies whether the web browser cookie (3) exist. If the web browser cookie (3) exists, the javascript (2) triggers the exit page redirection URL (9) within the web enabled mobile device web browser (7).

Embodiments of the present disclosure may advantageously utilize structured code that may alter the content within a web page that otherwise does not exist. The purpose of the code is to create additional methods of monetizing users whom exit a web page while they are using a web enabled mobile device. For example, the code determines whether the web enabled mobile device has previously visited the same web page that the code itself exists within. The code may be written in javascript and html or another similar programming language that can be executed through a web enabled mobile device web browser.

The web enabled mobile device web browser may first initiate a request to the web server. In response, the web server may then respond by delivering the code to the web enabled mobile device's browser. The code may then be executed within the web enabled mobile device browser and may also determine if a web browser cookie already exist.

The web browser cookie may be utilized in order to determine whether the web enabled mobile device has previously visited the same web page. If a web browser cookie does not already exist, a web browser cookie is placed on the web enabled mobile device and the web enabled mobile device web browser is then redirected to the desired web page. The desired web page is the web page that was initially requested by the web enabled mobile device.

Upon exiting the desired web page, either by using the hardware of the web enabled mobile device or the web enabled mobile device's web browser, the web enabled mobile device's web browser will return to the previous web page. The previous web page re-executes the javascript to see if a cookie exist. If the cookie exists on the web enabled mobile device, then the web enabled mobile devices web browser will redirect to a exit page redirection URL.

In some embodiments, the above process may be repeated to create multiple exit page redirection URLs. This would allow for multiple web pages to be displayed on the web enabled mobile device each time the web enabled mobile device exited the previous web page, however this is not required to operate the invention. Currently, no set limit exist on the number of exit page redirection URLs that could be used.

In some embodiments, the use of a javascript alert message could be included in the system or method, however, it is not required to operate the invention. Javascript alert messages may display information in a separate box on the web enabled mobile device. For example, Javascript alert messages might assume control over the web enabled mobile device web browser preventing the web enabled mobile device web browser from proceeding with any other task until the javascript alert message is closed. Data may also be collected from a user when using a javascript alert message.

Setting an expiration date with the web browser cookie can also be included in some embodiments. However, this is not required to operate the invention. The expiration date of a cookie may notify the web enabled mobile device's web browser when to delete the cookie.

A set of rules can be implemented to determine a relevant web page to display to the user. By using a rule set one could identify specific information on a user, such as, referring URL, destination URL, device model etc. and determine a relevant exit page redirection URL to redirect the web enabled mobile device. Some unique identifiers include, but are not limited to, carrier, device model, brand name, referring URL, destination URL, screen size, country, and/or publisher identification, for example. By opening a new window on the web enabled mobile device, while using the page that was originally opened to notify or place advertisements can achieve the same effect. The code to open a new window may look something like: target=“_blank” or target=“_new” for example. Variations of writing this code exist.

In some embodiments software may be included in the system or method that may allow for the advantages and processes described above.

Emerging technologies may allow for additional embodiments that are within the spirit and scope of the present disclosure, such as for example, the use of additional software and scripting languages that may allow for alternative means for monetizing exit website traffic on a web enabled mobile device. For example, utilizing flash instead of javascript or by utilizing server side redirection methodologies in the event that web enabled mobile devices are made to be capable of contacting a remote server upon exiting a web page through the use of a back button.

In a particular embodiment, all elements may be included However, different methods of constructing javascript code exist and could be rearranged to accomplish the same process described above and are within the spirit and scope of the present disclosure. Javascript code can be uniquely structured in many different patterns to accomplish the same goal.

A particular operating system on a web server is not required for embodiments of the present disclosure to work properly. For example, utilizing different Linux variants, Windows or similar web server operating systems can still achieve the invention.

Systems and methods of the present disclosure may be used as follows, in accordance with some embodiments. A user may add code to a web page that may detect if the back button of a web enabled mobile device or web enabled mobile device web browser has been pressed. By using code, the user can increase their return on investment by engaging their users in additional opportunities. Website owners can also notify or alert users about any type of information they wish to relay as a user exits a web page. Typically, marketers on the web may use embodiments of the present disclosure to provide additional opportunities for users. The webpage to which the user is redirected may simply be an advertisement, an offer, a coupon, or other marketing type of content.

It will be understood that while embodiments of the present disclosure have been discussed with regard to the use of mobile phones, similar technology that is within the spirit and scope of the present disclosure may use desktop and/or laptop computers.

In the foregoing description, various embodiments have been presented for the purpose of illustration and description. They are not intended to be exhaustive or to limit the disclosure to the precise forms disclosed. Obvious modifications or variations are possible in light of the above teachings. The embodiments were chosen and described to provide the best illustration of the principals of the present disclosure and its practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A method of providing a marketing opportunity on a webpage of a browser displayed on a mobile device, comprising:
receiving an indication that a user has pressed the “back” button;
identifying a cookie for the displayed webpage; and
upon receiving an indication that a “back” button has been pressed, redirecting to a webpage selected by a third party.
